(19) United States
(12) Patent Application Publication
(10) Pub. No.: US 2018/0143637 A1
(43) Pub. Date: May 24, 2018

(54) Visual tracking method and device, unmanned aerial vehicle and terminal device

(71) Applicant: SHANGHAI HANG SENG ELECTRONIC TECHNOLOGY, CO., LTD., Shanghai (CN)

(72) Inventors: Yu Tian, Kunshan (CN); Wenyan Jiang, Kunshan (CN)

(73) Assignee: SHANGHAI HANG SENG ELECTRONIC TECHNOLOGY, CO., LTD

(21) Appl. No.: 15/857,617

(22) Filed: Dec. 29, 2017

(30) Foreign Application Priority Data
Jan. 9, 2017 (CN) 201710014199.7

(51) Int. Cl. G05D 1/00; G06T 7/70; G06T 7/20; B64C 39/02

(52) U.S. Cl. CPC G05D 1/0094; G06T 7/70; B64C 2201/141; B64C 39/024; B64C 2201/123; G06T 7/20

(57) ABSTRACT

A visual tracking method and device, visual tracking device and terminal device are provided. The method includes steps of: obtaining image data at present of a designated area containing tracked objects and operating parameters of a tracking object; based on the image data at present of the designated area containing the tracked objects, obtaining at least one potential tracked object in the designated area to generate tracked object database to select the tracked objects; if the tracking object is determined to have relative movements with the tracked objects, establishing a motion estimation model of the tracked objects based on image characteristics of the tracked objects in the image data at present; based on the motion estimation model, predicting a position and the image characteristics of the tracked objects at a next moment in the image data of the designated area to control the tracking object.

### CROSS REFERENCE OF RELATED APPLICATION

The present application claims priority under 35 U.S.C. 119(a-d) to CN 201710014199.7, filed Jan. 9, 2017.

### BACKGROUND OF THE PRESENT INVENTION

### Field of Invention

The present invention relates to the field of the visual tracking technology, and more particularly to a visual tracking method, a visual tracking device, a drone and a terminal device.

### Description of Related Arts

The autonomous tracking in the conventional machines usually includes GPS (Global Position System) sensor based autonomous tracking and vision based autonomous tracking. The GPS sensor based autonomous tracking usually requires the tracked object carrying the sensor with GPS positioning function or other similar positioning sensors. The processing chip in the tracking device monitors the position of the tracked objects in real time and tracks the deviation of the current position of the tracking machine and the position of the target tracked object, so as to guide the tracking machine to follow the tracked objects. Such tracking method is highly limited and not capable of tracking the tracked objects without carrying sensors with GPS positioning function or similar positioning sensors. Some visual-based autonomous tracking methods, such as the UAV (unmanned aerial vehicle) visual tracking method, require active frame selection of the target object and detection thereof. Only when the tracked object satisfies the detection condition, the UAV is driven for tracking. The method may cause a result that when the user selects the tracking object in the image for several times, the tracked objects are still not capable of meeting the detecting condition due to human error, which cause a result that the UAV is not capable of performing tracking.

### SUMMARY OF THE PRESENT INVENTION

The present invention provides a visual control method and device, an unmanned aerial vehicle (UAV) and a terminal device.

Firstly, the present invention provides a visual tracking method comprising steps of:

S110: obtaining image data at present of a designated area containing tracked objects and operating parameters of a tracking object;

S120: based on the image data at present of the designated area containing the tracked objects, obtaining at least one potential tracked object in the designated area to generate tracked object database to select the tracked objects;

S130: if the tracking object is determined to have relative movements with the tracked objects, establishing a motion estimation model of the tracked objects based on image characteristics of the tracked objects in the image data at present; and

S140: based on the motion estimation model, predicting a position and the image characteristics of the tracked objects at a next moment in the image data of the designated area to control the tracking object.

Secondly, the present invention provides a visual tracking device, comprising:

an obtaining unit configured to obtain image data of a designated area containing tracked objects and operating parameters of a tracking object at present;

a selecting unit configured to obtain at least one potential tracked object in the designated area based on the image data at present of the designated area containing the tracked objects to generate tracked object database to select the tracked objects;

a processing unit configured to establish a motion estimation model of the tracked objects based on image characteristics of the tracked objects in the image data at present if the tracking object is determined to have relative movements with the tracked objects; and

a predicting unit configured to predict a position and the image characteristics of the tracked objects at a next moment in the image data of the designated area based on the motion estimation model to control the tracking object.

Thirdly, the present invention provides an unmanned aerial vehicle (UAV) comprising: an image collecting device, a platform, a flight control device, a communication device and the visual tracking device as recited in claim 8;

wherein the image collecting device is provided on the platform;

the visual tracking device is connected with the image collecting device for receiving image data of a designated area containing the tracked objects;

the visual tracking device is connected with the flight control device for receiving operating parameters of the unmanned aerial vehicle and sending a control instruction to the flight control device, wherein the control instruction comprises a position of the tracked objects in the image data of the designated area and image characteristics of the tracked objects which are obtained by predicting; and

the communication device is configured to communicate with a terminal device.

Fourthly, the present invention provides a terminal device, comprising: a communication device and the visual tracking device as recited in claim 8, wherein the visual tracking device is connected with the communication device; the visual tracking device obtains image data containing the designated area of the tracked objects sent by the tracking object and sends a control instruction to the tracking object; wherein the control instruction comprises the position of the tracked objects in the image data of the designated area and the image characteristics of the tracked objects obtained by predicting.

The unmanned aerial vehicle or the terminal device provided with the visual tracking device mentioned above obtains the potential tracked object in the designated area by obtaining image data at present of the designated area containing the tracked object to generate a tracked object database to select the tracked objects, which is capable of decreasing the impact of human manipulation on the selection of the tracked objects, so that the selection of the tracked objects is more rapid and accurate. Meanwhile, the present invention establishes the motion estimation model of the tracked objects based on the image characteristics of the tracked objects, so as to predict the position of the tracked object at a next moment in the image data of the designated area and the image characteristics to achieve precise control of the tracked object for tracking purpose.

### BRIEF DESCRIPTION OF THE DRAWINGS

In order to illustrate the technical solution in the preferred embodiment of the present invention more clearly, the accompanying drawings applied in the preferred embodiment of the present invention are briefly introduced as follows. Apparently, the accompanying drawings described below are merely examples of the preferred embodiments of the present invention. One skilled in the art may also obtain other drawings based on these accompanying drawings without creative efforts.

FIG. 1 is a sketch flow chart of a visual tracking method according to a first preferred embodiment of the present invention.

FIG. 2 is a schematic block diagram of a visual tracking device according to the first preferred embodiment of the present invention.

FIG. 3 is a schematic block diagram of an unmanned aerial vehicle (UAV) according to a second preferred embodiment of the present invention.

FIG. 4 is a schematic block diagram of a terminal device according to a third preferred embodiment of the present invention.

FIG. 5 is a schematic block diagram implemented by a computing device of the visual tracking device according to the first preferred embodiment of the present invention.

### DETAILED DESCRIPTION OF THE PREFERRED EMBODIMENT

In order to make the objectives, technical solutions and advantages of the preferred embodiments of the present invention more comprehensible, the technical solutions in the embodiments of the present invention are clearly and completely described combining with the accompanying drawings in the preferred embodiments of the present invention. Apparently, the preferred embodiments are only a part but not all of the embodiments of the present invention. All other embodiments obtained by people skilled in the art based on the preferred embodiments of the present invention without creative efforts shall fall within the protection scope of the present invention.

The features and exemplary embodiments of various aspects of the present invention are described in detail below. In the following detailed description, a plurality of specific details is set forth in order to provide a thorough understanding of the present invention. However, it will be apparent to one skilled in the art that the present invention may be embodied without some of these specific details. The following description of the embodiments is merely for providing a better understanding of the present invention by showing examples of the present invention. The present invention is not limited to any specific configuration and algorithm set forth below, but covers any alterations, substitutions and improvements of the elements, components and algorithms without departing from the spirit of the present invention. In the drawings and the following descriptions, well-known structures and techniques are not shown, so as to avoid unnecessarily obscuring the present invention.

Preferred embodiments will now be described more fully with reference to the accompanying drawings. However, the preferred embodiments may be embodied in to many forms and should not be construed as limited to the embodiments set forth herein;

rather, these embodiments are provided so that the disclosure will be thorough and complete, so as to fully convey the concepts of the example embodiments to those skilled in the art. In the drawings, the thickness of regions and layers may be exaggerated for clarity. Identical reference numerals in the drawings denote the identical or similar structures, and thus their detailed descriptions will be omitted.

Furthermore, the described features, structures, or characteristics may be combined in any suitable manner in one or more preferred embodiments. In the following description, numerous specific details are given to provide a thorough understanding of preferred embodiments of the present invention. However, those skilled in the art will recognize that the aspects of the invention may be practiced without one or more of the specific details or by employing other methods, components, materials, and etc. In other instances, well-known structures, materials, or operations are not shown or described in detail to avoid obscuring the primary technical innovation of the present invention.

It is worth mentioning that in the case of no conflict, the preferred embodiments in the present invention and the characteristics in the preferred embodiments may be combined with each other. The present application will be illustrated in detail below with reference to the accompanying drawings and the preferred embodiments.

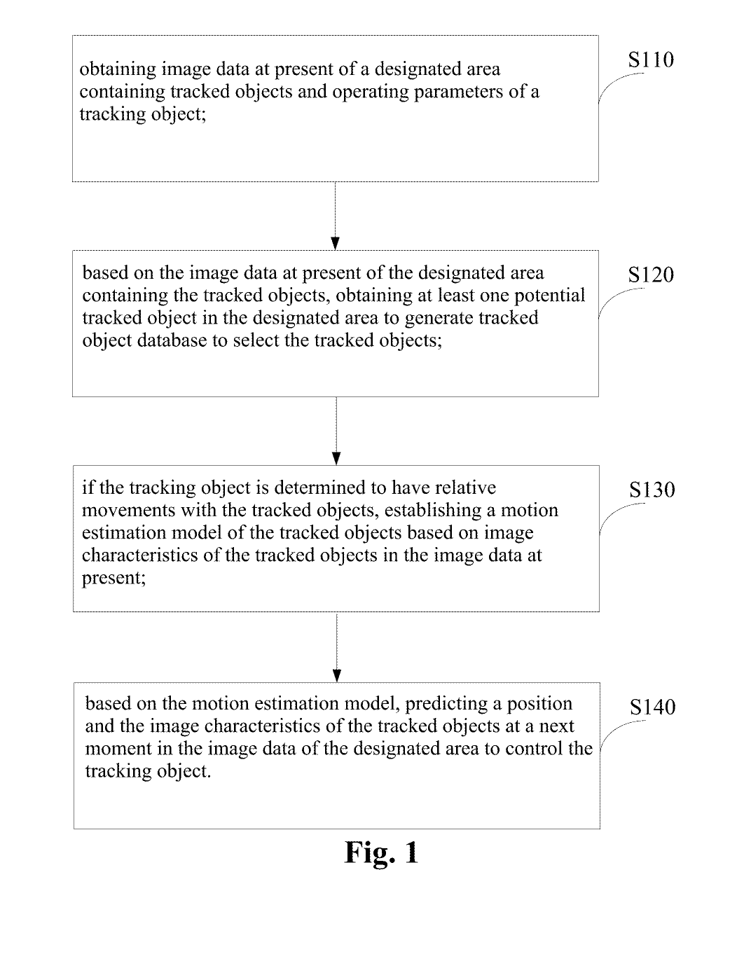

FIG. 1 is a sketch flow chart of a visual tracking method according to a first preferred embodiment of the present invention. The visual tracking method comprises steps of:

S110: obtaining image data at present of a designated area containing a tracked object and an operating parameter of a tracking object;

S120: based on the image data at present of the designated area containing the tracked objects, obtaining at least one potential tracked object in the designated area to generate tracked object database to select the tracked objects;

S130: if the tracking object is determined to have relative movements with the tracked objects, establishing a motion estimation model of the tracked objects based on image characteristics of the tracked objects in the image data at present; and

S140: based on the motion estimation model, predicting a position and the image characteristics of the tracked objects at a next moment in the image data of the designated area to control the tracking object.

Based on obtaining the image data at present in the designated area containing the tracked objects, the method is capable of obtaining the potential tracked objects in the designated area to generate the tracked object database to select the tracked objects, which is capable of decreasing influence of hand manipulation on selection of the tracked objects, in such a manner that the selection of the tracked objects are more rapid and accurate. In addition, the method establishes the motion estimation model of the tracked objects based on the image characteristics of the tracked objects, and further predicts the position and the image characteristics of the tracked objects at the next moment in the image data of the designated area to achieve precise control of the tracking objects for tracking purpose.

In the step S110, the image data at present of the designated area containing the tracked object can be obtained by an image collection device provided on the tracking object. Taking the tracking object as an unmanned aerial vehicle (UAV) as an example, the image collection device can be a camera provided on a holder of the UAV.

The step S120 may further comprises one or more steps of:

selecting the tracked objects based on types of the tracked objects;

selecting a selected position in the image data, and selecting the tracked objects according to a distance between the potential tracked object and the selected position; and

displaying the tracked object selected and/or characteristics of the tracked object selected to manually confirm the tracked objects selected.

In some embodiments, the tracked objects can be preliminarily selected according to types of the tracked objects. For example, the tracked objects are preliminarily selected according to whether the tracked object is a person, a car, an animal and etc. The selected position is selected in the image data, wherein selecting the tracked objects according to the distance between the potential tracked objects and the selected position serves as a further step for selecting the selected objects. The step of displaying the tracked object selected and/or characteristics of the tracked object selected to manually confirm the tracked objects selected serves as a last step to confirm the tracked objects. For example, after the tracked objects are selected according to the distance to the selected position, the tracked objects identified are popped up in the display device, allowing the user whether it is the tracked object of their choice.

According to some examples, the method further comprises predicting the position of the tracked objects obtained by predicting at the next moment in the image data of the designated area by a nuclear filter tracking algorithm; so as to find and obtain a precise position of the tracked objects. According to some examples, the image characteristics of the tracked objects comprise color and edge gradient of the tracked objects. According to some examples, the method further comprises: based on the motion estimation model, predicting the position and the image characteristics of the tracked objects at the next moment in the image data of the designated area to obtain a coordinate of the tracked objects at the next moment in the image data of the designated area; such as based on the coordinate of the image data and the operating parameter of the tracked objects to obtain a three-dimensional relative operating parameter of the tracking object and the tracked objects; for instance, establishing a conversion model between a two-dimensional coordinates of an image and a three-dimensional coordinates of an actual space, so as to convert motion data of adjacent frames in the image of the tracked objects to an actual displacement and direction control instruction for controlling the tracking object to perform corresponding movement action. According to a preferred embodiment of the present invention, the coordinates obtained from the image data can be directly input to a control device of the tracking device, and the device obtains the three-dimensional relative operating parameter of the tracking object and the tracked objects according to the operating parameters stored in the control device, so as to control the tracking object.

According to some embodiments, the method further comprises a step of: based on the motion estimation model, predicting a position and the image characteristics of the tracked objects at a next moment in the image data of the designated area to update the motion estimation model.

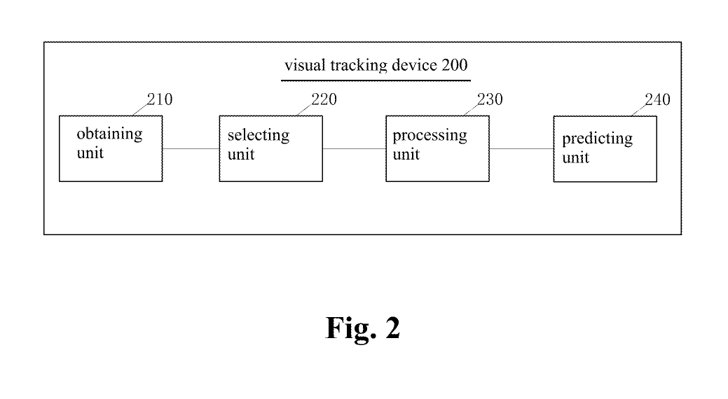

The visual tracking method of the preferred embodiments of the present invention is illustrated above in detail combining with the FIG. 1 of the drawings. A visual device, an unmanned aerial vehicle and a terminal device are illustrated in detail below combining with the FIGS. 2-5 of the drawings.

FIG. 2 is a schematic block diagram of a visual tracking device according to the first preferred embodiment of the present invention. As shown in FIG. 2, the visual tracking device 200 comprises: an obtaining unit 210, a selecting unit 220, a processing unit 230 and a predicting unit 240; wherein the obtaining unit 210 is configured to obtain image data of a designated area containing a tracked object and operating parameters of a tracking object at present; the selecting unit 220 is configured to obtain at least one potential tracked object in the designated area based on the image data at present of the designated area containing the tracked objects to generate tracked object database to select the tracked objects; the processing unit 230 is configured to establish a motion estimation model of the tracked objects based on the image characteristics of the tracked objects in the image data at present if the tracking object is determined to have relative movements with the tracked objects; and the predicting unit 240 is configured to predict a position and the image characteristics of the tracked objects at a next moment in the image data of the designated area based on the motion estimation model to control the tracking object. According to a preferred embodiment of the present invention, the visual tracking device 200 may correspond to an executive body of the visual tracking method according to the preferred embodiment of the present invention. In addition, operations and/or functions mentioned above and in other situations of each unit of the visual tracking respectively achieve corresponding flow of each process in the FIG. 1, which is not repeated here for brevity.

In the preferred embodiment, the visual tracking device by obtaining the image data at present of the designated area containing the tracked objects to obtain potential tracked object in the designated area to generate tracked object database to select the tracked objects, in such a manner that the influence of manual operation on selection of the tracked objects are capable of being decreased, so that the selection of the tracked objects are more rapid and accurate. Meanwhile, the motion estimation model of the tracked objects is established based on the image characteristics of the tracked objects, so as to predict a position and the image characteristics of the tracked objects at a next moment in the image data of the designated area to achieve a precise control of the tracking object for tracking purpose.

According to some embodiments, the device further comprises a filter unit configured to predict the position of the tracked objects obtained by predicting at the next moment in the image data of the designated area by a nuclear filter tracking algorithm.

In some embodiments, the image characteristics of the tracked objects comprise color and edge gradient of the tracked objects.

In some embodiments, the predicting unit is configured to predict the position and the image characteristics of the tracked objects at the next moment in the image data of the designated area based on the motion estimation model to obtain a coordinate of the tracked objects at the next moment in the image data of the designated area.

In some embodiments, the selecting unit is configured to perform one or more of steps as follows:

selecting the tracked objects based on types of the tracked objects;

selecting a selected position in the image data, and selecting the tracked objects according to a distance between the potential tracked object and the selected position; and

displaying the tracked object selected and/or characteristics of the tracked object selected to manually confirm the tracked objects selected.

In some embodiments, the visual tracking device comprises an updating unit configured to update the motion estimation model configured to predict the position and the image characteristics of the tracked objects based on the motion estimation model at the next moment in the image data of the designated area to update the motion estimation model.

In some embodiments, the visual tracking device further comprises a coordinate conversion unit configured to obtain three-dimensional relative operation parameters of the tracking object and the tracked object based on the coordinate in the image data and the operating parameters of the tracking object.

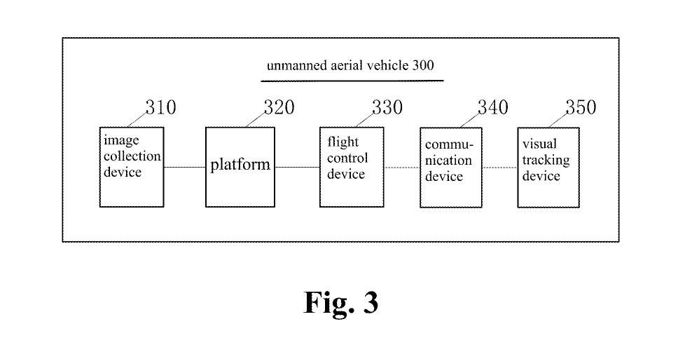

The visual tracking device can be applied in various tracking objects such as the unmanned aerial vehicle. FIG. 3 is a schematic block diagram of an unmanned aerial vehicle (UAV) according to a second preferred embodiment of the present invention. As shown in FIG. 3, the unmanned aerial vehicle 300 comprises: an image collecting device 310, a platform 320, a flight control device 330, a communication device 340 and the visual tracking device 350 mentioned above; wherein the image collecting device 310 is provided on the platform 320; the visual tracking device 350 is connected with the image collecting device 310 for receiving image data of a designated area containing the tracked objects; the visual tracking device 350 is connected with the flight control device 330 for receiving operating parameters of the unmanned aerial vehicle and sending a control instruction to the flight control device 330, wherein the control instruction comprises a position of the tracked objects in the image data of the designated area and the image characteristics which are obtained by predicting; the communication device 340 is configured to communicate with a terminal device. According to an embodiment, the platform comprises a platform control module configured to automatically regulate the platform according to the flight position of the unmanned aerial vehicle, so as to ensure that image captured by a camera provided on the platform is stable.

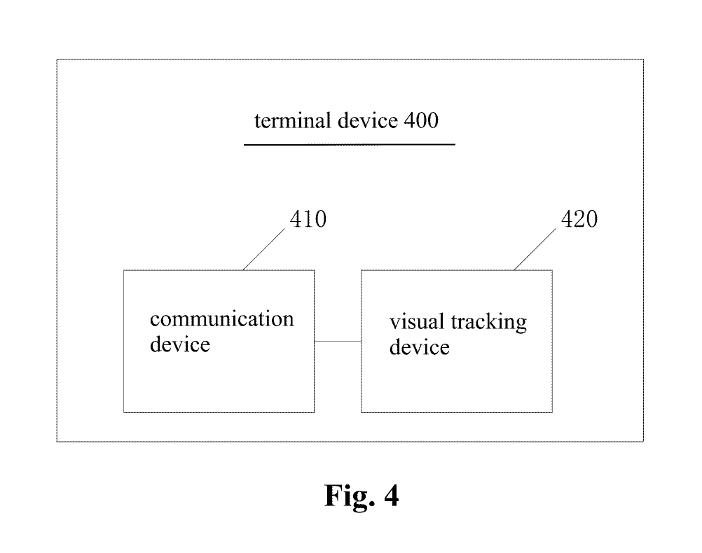

The visual tracking device mentioned above is capable of being applied in various terminal devices such as mobile phone. FIG. 4 is a schematic block diagram of a terminal device according to a third preferred embodiment of the present invention. As shown in FIG. 4, the terminal device 400 comprises the communication device 410 and the visual tracking device 420 mentioned above; wherein the visual tracking device 420 is connected with the communication device 410; the visual tracking device 420 obtains image data containing the designated area of the tracked objects sent by the tracking object and sends a control instruction to the tracking object; wherein the control instruction comprises the position of the tracked objects in the image data of the designated area obtained by predicting and the image characteristics.

The unmanned aerial vehicle or the terminal device provided with the visual tracking device mentioned above obtains the potential tracked object in the designated area by obtaining image data at present of the designated area containing the tracked object to generate a tracked object database to select the tracked objects, which is capable of decreasing the impact of human manipulation on the selection of the tracked objects, so that the selection of the tracked objects is more rapid and accurate. Meanwhile, the present invention establishes the motion estimation model of the tracked objects based on the image characteristics of the tracked objects, so as to predict the position of the tracked object at a next moment in the image data of the designated area and the image characteristics to achieve precise control of the tracked object for tracking purpose.

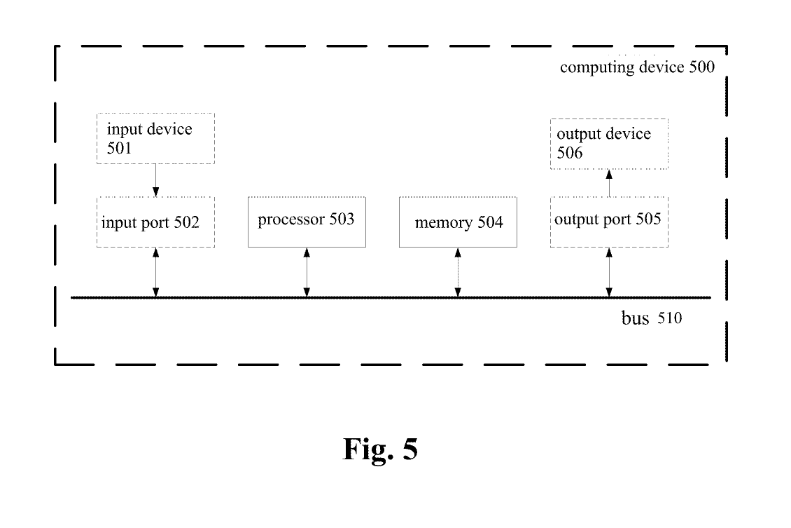

FIG. 5 is a schematic block diagram implemented by a computing device of the visual tracking device according to the first preferred embodiment of the present invention. As shown in FIG. 5, at least a portion of the visual tracking device can be implemented by the computing device 500. The computing device 500 comprises a memory 504, a processor 503 and a bus 510; wherein the memory 504 is connected with the processor 503 via the bus for communicating with each other; the memory 504 is configured to store program codes; the processor 530 reads an executable program code stored in the memory 504 to operate a program corresponding to the executable program code, so as to execute the visual tracking method as shown in FIG. 1. In some embodiments, the computing device 500 further comprises: an input device 501, an input terminal 502, an output port 505 and an output device 506; wherein the input port 502, the processor 503, the memory 504 and the output port are connected with each other by the bus 510; the input device 501 and the output device 506 are respectively connected with the bus 510 via the input port 502 and the output port 505, so as to further connect other components of the computing device 500. It is worth mentioning that the output port 505 and the input port 506 can be represented by I/O interfaces. Specifically, the output device 501 receives input information from outside and transmits the input information to the processor 503 via the input port 502; the processor processes the input information based on the computer-executable instructions to generate output information; the output information is temporarily or permanently stored in the memory 504, and then the output information is transmitted to the output device 506 via the output port 505; the output device 506 outputs the output information out of the computing device 500.

The computing device 500 may adopt ARM (advanced RISC machines) processor or GPU (graphics processing unit) for serving as a control processor 530. The computing device 500 further comprises an algorithm acceleration module configured to provide on a hardware of a terminal device, for example, the ARM processor or the GPU graphics processing unit performs parallel computing on the processing unit 230 and the predicting unit 240, so as to reduce the time complexity of the algorithm and improve the real time performance and the accuracy of the system.

The memory 504 mentioned above comprises a mass memory for data or instructions. For instance and not for limitation, the memory 504 comprises an HDD (hard disk drive), a floppy disk drive, a flash memory, an optical disk, a magneto-optical disk, a magnetic tape, or a universal serial bus (USB) drive or a combination of two or more of these. Where appropriate, the memory 504 comprises a removable or non-removable or fixed medium. Where appropriate, the memory 504 can be internally or externally provided on the computing device 500. According to a particular embodiment, the memory 504 is a non-volatile solid-state memory. In a particular embodiment, the memory 504 comprises a read only memory (ROM). Where appropriate, the ROM may be a mask-programmed ROM, a programmable ROM (PROM), an erasable PROM (EPROM), an electrically erasable PROM (EEPROM), an electrically rewritable ROM (EAROM), a flash memory or a combination of two or more of these.

The bus 510 comprises one or both of a hardware and a software. The bus 510 couples components of the computing device 500 to each other. For example, and not limitation, the bus 510 may comprises an Accelerated Graphics Port (AGP) or other graphics bus, an Enhanced Industry Standard Architecture (EISA) bus, a Front Side Bus (FSB), a Hyper Transport (HT) interconnect, an Industry Standard Architecture (ISA) bus, an InfiniBand interconnect, a low pin count (LPC) bus, a memory bus, a Micro Channel Architecture (MCA) bus, a Peripheral Component Interconnect (PCI) bus, a PCI-Express (PCI-X) bus, A SATA (Serial Advanced Technology Attachment) bus, a Video Electronics Standards Association local bus (VLB), other suitable buses, or a combination of two or more of these. Where appropriate, an amount of the bus 510 is one or multiple. Although specific buses are described and illustrated in the embodiments of the present invention, any suitable bus or interconnect is within the scope of the present invention.

When the computing device 500 in the FIG. 5 is utilized to achieve combining the visual tracking device in the FIG. 2, the input device 501 receives the image data at present of the designated area containing the tracked objects and operating parameters of the tracked objects. In a particular embodiment, The I/O interface connected to the output device may comprises a hardware, a software, or both; one or more interfaces for communication are provided between the computing device 500 and one or more I/O devices. Where appropriate, the computing device 500 comprises one or more of these I/O devices. One or more of these I/O devices may allow for communication between people and the computing device 500. For example, and not limitation, the I/O devices comprise: a keyboard, a keypad, a microphone, a monitor, a mice, a printer, a scanner, a speaker, a still camera, a stylus, a tablet, a touch screen, a trackball, a video camera, another suitable I/O device, or a combination of two or more of these mentioned above. The I/O devices may comprise one or more sensors. The embodiments of the present invention can be applied in any suitable I/O device and any suitable I/O interface. Where appropriate, the I/O interfaces may comprise one or more devices or software drivers capable of allowing the processor 503 to drive one or more of the I/O devices. Where appropriate, I/O interfaces may comprise one or more I/O interfaces. Although specific I/O interfaces are described and illustrated in the embodiments of the present invention, any other suitable I/O interface can be applied in the embodiments of the present invention. Based on the executable program code stored in the memory 504 and based on the image data at present of the designated area containing the tracked objects, the processor 503 obtains potential tracked objects in the designated area to generate tracked objects database to select the tracked objects. If the tracking object is determined to have relative movements with the tracked objects, establish a motion estimation model of the tracked objects based on the image characteristics of the tracked objects in the image data at present; and based on the motion estimation model, predict a position and the image characteristics of the tracked objects at a next moment in the image data of the designated area to control the tracking object. Then the control instruction containing the tracked objects mentioned above is output to the tracking object via the output port 505 and the output device 506.

Where appropriate, the executable program code may comprise one or more semiconductor-based integrated circuit or other integrated circuits (ICs) such as a field programmable gate array (FPGA), an application specific IC (ASIC), a hard disk drive (HDD), hybrid hard disk drive (HHD), an optical disk, an optical disk drives (ODD), a magneto optical disk, a magneto optical disk drive, a floppy disk, a floppy disk drive (FDD), a magnetic tape, a holographic storage media, a solid state drives (SSD), an RAM drive, a secure digital card, a drive or other suitable computer-readable non-transitory storage medium or a combination of two or more of these elements.

It is worth mentioning that the present invention is not limited to the particular configurations and processes described above and illustrated in the figures. And for simplicity, the detailed description of the method in the conventional art is omitted here. In the embodiments mentioned above, several specific steps are described and illustrated as examples. However, the process of the present invention is not limited to the specific steps described and shown above and various changes, modifications and additions may be made by those skilled in the art after learning the spirit of the present invention or orders between the steps can be changed.

In addition, each functional unit in each embodiment of the present invention may be integrated in one processing unit, or each unit may exist alone physically, or two or more units may be integrated in one unit. The above-mentioned integrated unit can be implemented in the form of hardware or in the form of software functional unit.

The foregoing descriptions are merely preferred embodiments of the present invention; the protection scope of the present invention is not limited thereto. Any skilled in the art may easily think of various equivalent modifications or replacements, these modifications or replacements should be covered in the protection scope of the present invention. Therefore, the protection scope of the present invention should be subject to the protection scope of the claims.

What is claimed is:

1. A visual tracking method comprising steps of:
S110: obtaining image data at present of a designated area containing tracked objects and operating parameters of a tracking object;
S120: based on the image data at present of the designated area containing the tracked objects, obtaining at least one potential tracked object in the designated area to generate tracked object database to select the tracked objects;
S130: if the tracking object is determined to have relative movements with the tracked objects, establishing a motion estimation model of the tracked objects based on image characteristics of the tracked objects in the image data at present; and
S140: based on the motion estimation model, predicting a position and the image characteristics of the tracked objects at a next moment in the image data of the designated area to control the tracking object.

2. The visual tracking method, as recited in claim 1, further comprising a step of predicting the position of the tracked objects, which is obtained by predicting, at the next moment in the image data of the designated area by a nuclear filter tracking algorithm.

3. The visual tracking method, as recited in claim 1, wherein the image characteristics of the tracked objects comprise color and edge gradient of the tracked objects.

4. The visual tracking method, as recited in claim 1, wherein the step S140: based on the motion estimation model, predicting the position and the image characteristics of the tracked objects at a next moment in the image data of the designated area to control the tracking objects comprises: based on the motion estimation model, predicting the position and the image characteristics of the tracked objects at the next moment in the image data of the designated area to obtain a coordinate of the tracked objects at the next moment in the image data of the designated area.

5. The visual tracking method, as recited in claim 1, wherein the step S120: based on the image data at present of the designated area containing the tracked objects, obtaining at least one potential tracked object in the designated area to generate tracked object database to select the tracked objects comprises one or more steps of:
selecting the tracked objects based on types of the tracked objects;
selecting a selected position in the image data, and selecting the tracked objects according to a distance between the potential tracked object and the selected position; and
displaying the tracked object selected and/or characteristics of the tracked object selected to manually confirm the tracked objects selected.

6. The visual tracking method, as recited in claim 1, further comprising a step of based on the motion estimation model, predicting a position and the image characteristics of the tracked objects at a next moment in the image data of the designated area to update the motion estimation model.

7. The visual tracking method, as recited in claim 4, further comprising a step of based on the coordinate of the image data and the operating parameters of the tracked objects to obtain a three-dimensional relative operating parameter of the tracking object and the tracked objects.

8. A visual tracking device, comprising:
an obtaining unit configured to obtain image data of a designated area containing tracked objects and operating parameters of a tracking object at present;
a selecting unit configured to obtain at least one potential tracked object in the designated area based on the image data at present of the designated area containing the tracked objects to generate tracked object database to select the tracked objects;
a processing unit configured to establish a motion estimation model of the tracked objects based on image characteristics of the tracked objects in the image data at present if the tracking object is determined to have relative movements with the tracked objects; and
a predicting unit configured to predict a position and the image characteristics of the tracked objects at a next moment in the image data of the designated area based on the motion estimation model to control the tracking object.

9. The visual tracking device, as recited in claim 8, further comprising a filter unit configured to predict the position of the tracked objects obtained by predicting at the next moment in the image data of the designated area by a nuclear filter tracking algorithm.

10. The visual tracking device, as recited in claim 8, wherein the image characteristics of the tracked objects comprise color and edge gradient.

11. The visual tracking device, as recited in claim 8, wherein the predicting unit is configured to predict the position and the image characteristics of the tracked objects at the next moment in the image data of the designated area based on the motion estimation model to obtain a coordinate of the tracked objects at the next moment in the image data of the designated area.

12. The visual tracking device, as recited in claim 8, wherein the selecting unit is configured to perform one or more of steps as follows:
selecting the tracked objects based on types of the tracked objects;
selecting a selected position in the image data, and selecting the tracked objects according to a distance between the potential tracked object and the selected position; and
displaying the tracked object selected and/or characteristics of the tracked objects selected to manually confirm the tracked objects selected.

13. The visual tracking device, as recited in claim 8, further comprising an updating unit configured to predict the position and the image characteristics of the tracked objects based on the motion estimation model at the next moment in the image data of the designated area to update the motion estimation model.

14. The visual tracking device, as recited in claim 11, further comprising a coordinate conversion unit configured to obtain three-dimensional relative operation parameters of the tracking object and the tracked object based on the coordinate in the image data and the operating parameters of the tracking object.

15. An unmanned aerial vehicle (UAV) comprising: an image collecting device, a platform, a flight control device, a communication device and the visual tracking device as recited in claim 8;
wherein the image collecting device is provided on the platform;
the visual tracking device is connected with the image collecting device for receiving image data of a designated area containing the tracked objects;
the visual tracking device is connected with the flight control device for receiving operating parameters of the unmanned aerial vehicle and sending a control instruction to the flight control device, wherein the control instruction comprises a position of the tracked objects in the image data of the designated area and image characteristics of the tracked objects which are obtained by predicting;
the communication device is configured to communicate with a terminal device.
